(19) United States
(12) Patent Application Publication
(10) Pub. No.: US 2007/0254676 A1
(43) Pub. Date: Nov. 1, 2007

(54) Assisting A Location-Determining System Using Location Determined From A Communication System

(75) Inventors: Madison F. Pedigo, Allen, TX (US); Carl M. Panasik, Garland, TX (US)

Correspondence Address: TEXAS INSTRUMENTS INCORPORATED, P O BOX 655474, M/S 3999, DALLAS, TX, 75265, US

(73) Assignee: Texas Instruments, Inc., Dallas, TX (US)

(21) Appl. No.: 11/380,839

(22) Filed: Apr. 28, 2006

(51) Int. Cl. H04Q 7/20

(52) U.S. Cl. 455/456.6

(57) ABSTRACT

A mobile device comprises a location-determining subsystem and a location assistance subsystem operatively coupled to the location-determining subsystem. The second location assistance subsystem wirelessly communicates with a second transceiver that is external to said mobile device to receive location information of the second transceiver. The location information is used by the first location-determining subsystem.

### CROSS-REFERENCE TO RELATED APPLICATIONS

This application relates to the following commonly assigned co-pending application entitled: “Location Determination With A Wireless System,” Ser. No. ______, filed ______, Attorney Docket No. TI-60799 (1962-30200); of which is incorporated by reference herein.

### BACKGROUND

1. Technical Field

The present disclosure relates generally to assisting a location-determining system with location assistance determined from a communication system. More particularly, the present disclosure relates to using a short-range communication system, such as radio frequency identification (RFID), to, for example, streamline a satellite search for a global positioning system (GPS) receiver or to synchronize an inertial navigation system.

2. Background Information

Various types of location-determining systems exist. A global positioning system (GPS), for example, uses a network of satellites in earth orbit that transmits signals at a known time. A GPS receiver on the ground measures the time of arrival of the signals from each satellite that the receiver can “see.” The time of arrival of the signal along with the location of the satellites and the time the signal was transmitted from each satellite are used to triangulate the absolute position of the GPS receiver. A GPS receiver uses three or more satellites to perform the triangulation. The accuracy of the resulting position location increases as the number of satellites whose signals are used increases.

One problem with GPS arises if less than three satellites can be found by the receiver. Such a situation may occur, for example, if the GPS receiver's view of the sky is obstructed (e.g. in or near a tall building). If a signal from a satellite is lost, the receiver is forced to search for a new satellite. Another problem with GPS relates to the amount of time the GPS receiver requires to scan the sky to locate all available satellites (a “cold start”). GPS signals from satellites are nearly line-of-sight and inherently weak, and therefore finding all available satellites may take a substantial amount of time. Reducing the time to locate one or more GPS satellites would be desirable.

Another type of location-determining system comprises an inertial navigation system. Such systems use one or more gyroscopes and/or accelerometers to determine velocity, heading, and position relative to a known starting point. Inertial navigation systems generally suffer from “navigation drift” in which small errors in measurement aggregate into progressively larger errors in calculations of relative velocity and position. Solutions to this problem are also desirable.

### BRIEF SUMMARY

In general, a mobile device is described that comprises a first location-determining subsystem and a second location assistance subsystem operatively coupled to the first location-determining subsystem. The second location assistance subsystem wirelessly communicates with a second transceiver that is external to the mobile device to receive location information of the second transceiver. The location information is used by the first location-determining subsystem.

In accordance with another embodiment, a mobile device comprises a location-determining subsystem and a first transceiver coupled to the location-determining subsystem and adapted to wirelessly communicate with a second transceiver that is external to the mobile device. The second transceiver is positioned at a fixed location and comprises location information indicative of the fixed location. The first transceiver causes the second transceiver to transmit the location information to the first transceiver and the location information is used by the location-determining subsystem.

In another embodiment, a method comprises a mobile device determining location of a component external to the mobile device and using the external components location for assisting the location determining subsystem of the mobile device. The location-determining subsystem comprises a subsystem selected from a group consisting of a global positioning system (GPS) and an inertial navigation system.

These and other embodiments are described below.

### Notation and Nomenclature

Certain terms are used throughout the following description and claims to refer to particular system components. As one skilled in the art will appreciate, different companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection, or through an indirect connection via other devices and connections.

### BRIEF DESCRIPTION OF THE DRAWINGS

For a more detailed description of the preferred embodiments of the present invention, reference will now be made to the accompanying drawings, wherein:

FIG. 1 shows a system diagram in accordance with a preferred embodiment of the invention;

FIG. 2 shows additional detail of a system in accordance with a preferred embodiment of the invention; and

FIG. 3 shows a method in accordance with embodiments of the invention.

### DETAILED DESCRIPTION OF THE PREFERRED EMBODIMENTS

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be exemplary of that embodiment, and not intended to intimate that the scope of the disclosure, including the claims, is limited to that embodiment.

The disclosed embodiments are directed to the use of a relatively short-range (e.g., 200 feet or less) communication infrastructure, such as radio frequency identification (RFID), to estimate or infer an approximate or exact location of a mobile device and then to use that location as an input to another location-determining system. In some embodiments, such other location-determining systems comprise a global positioning system (GPS) receiver or an inertial navigation system. For a GPS receiver, the RFID (or other)-determined location of the mobile device can be used to streamline satellite searching that the GPS receiver performs (e.g., a cold start). For an inertial navigation system, the location of the mobile device can be used for synchronization, that is, to reset the known position from which the relative position of the mobile device is computed or to estimate a new position for the mobile device.

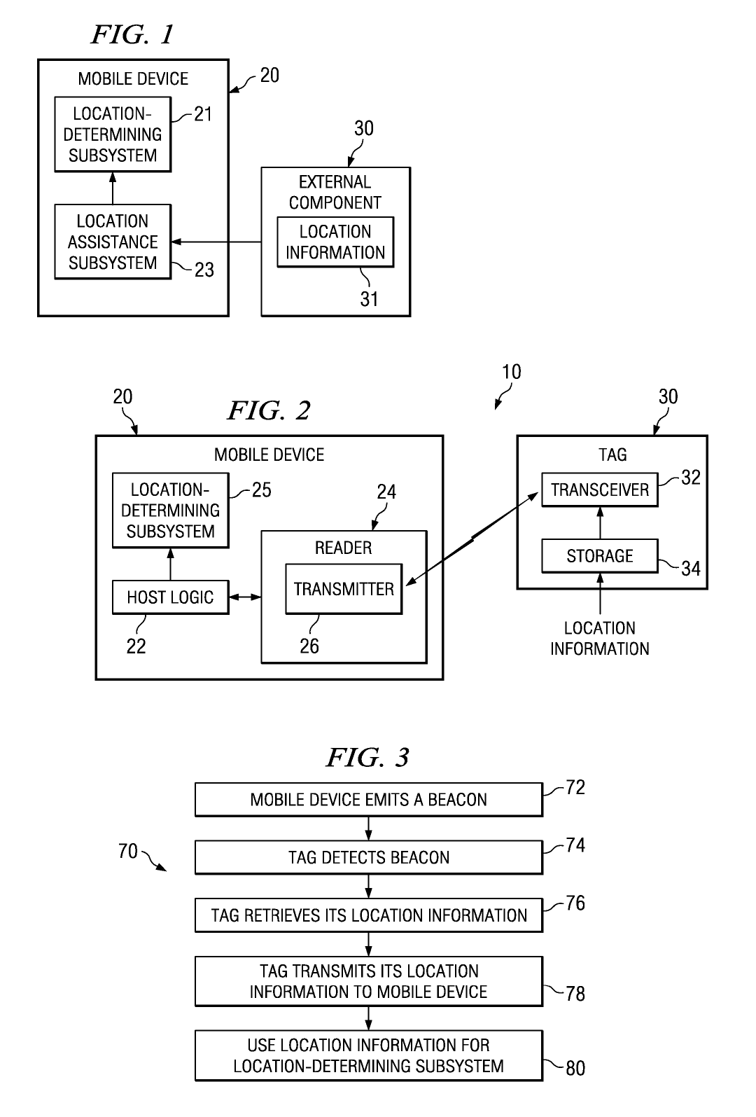

FIG. 1 shows a communication system comprising one or more mobile devices 20 and one or more components 30 that are external to the mobile device 20. The mobile device 20 comprises a location-determining subsystem 21 operatively coupled to a location assistance subsystem 23. Both subsystems 21 and 23 may couple to host logic (not shown in FIG. 1). The external component 30 is located at a fixed position and thus its location is known and stored in, or otherwise accessible to, the external component as location information 31. In accordance with a preferred embodiment, the location assistance subsystem 23 wirelessly communicates with a transceiver (not specifically shown) in the external component 30 to receive location information 31 of the external component and/or its transceiver. The location information is used to assist the location-determining subsystem 21 in its operation.

In some embodiments, the location-determining subsystem 21 comprises a GPS receiver which determines absolute location (subject to a circle of probability of error in the calculation) of the location-determining subsystem 21, while in other embodiments, the location-determining subsystem determines location relative to a predetermined point. An example of the latter type of location-determining subsystem is an inertial navigation system. The location information 31 of the external device is used to estimate or infer the location of the mobile device and is also used by the location-determining subsystem 21. In the example in which the location-determining subsystem comprises a GPS receiver, the location information is used to search for a satellite (e.g., a cold start). In the example in which the location-determining subsystem is an inertial navigation system, the location information is used to synchronize or update the inertial navigation system. In some embodiments, the location assistance subsystem 23 comprises a radio frequency identification (RFID) reader or tag or Near Field Communication (NFC) transponder. In such an embodiment, the location of the external component 30 is provided to the location assistance subsystem 23 via an RFID (or NFC) protocol and the location information is used to synchronize an inertial navigation system or assist in a satellite search procedure for a GPS receiver. In general, the location assistance subsystem 23 receives a location of an external component which implies something about the location of the mobile device 20. That is, if the mobile device 20 is fairly close to the external component and the location of the external component is known, information regarding the location of the mobile device is then known, estimated or can be inferred. The location of the external component can then be used to assist the location-determining subsystem 21 in its operation (to determine location).

FIG. 2 shows a system 10 in accordance with preferred embodiments of the invention. The embodiment of FIG. 2 shows an embodiment of the mobile device 20 of FIG. 1 and the external component 30 implemented as a “tag.” The location-determining system 21 of FIG. 1 is shown as the location-determining subsystem 25 in FIG. 2. The location assistance system 23 of FIG. 1 is shown as a reader 24 and/or host logic 22 in the example of FIG. 2. The reader 24 comprises a transceiver 26. If desired, other components may be included with the mobile device 20 and tag 30.

The mobile device 20 may comprise any of a variety of mobile devices such as cellular telephones, personal data assistants (PDAs), computers, etc. The host logic 22 performs one or more functions associated with the general functionality of the mobile device. For example, in the case of a cellular telephone, the host logic 22 may comprise a radio (preferably separate and apart from the transceiver 26), a keypad, a display, and control logic (e.g., a processor) to control the operation of the cellular telephone. In the case of a PDA or computer, the host logic 22 comprises a processor, memory, and other components typical of such devices.

The following discussion explains how the mobile device 20 determines its location via RFID, although other short-range wireless, optical, or other techniques can be used instead. Via the transceivers 26 and 32, the mobile device 20 and tag 30 wirelessly communicate with each other. In accordance with one embodiment of the invention, the reader 24 of the mobile device and the tag 30 are provided in accordance with the radio frequency identification (RFID) protocol. As such, the reader 24 comprises an RFID reader and the tag 30 comprises an RFID tag. Unless otherwise specified, as used herein, the term “tag” is not limited to the RFID context. The tag 30 preferably is positioned at a fixed location such as on a wall, furniture, or piece of equipment. In other embodiments, the mobile device 20 comprises a tag and the system 10 comprises a reader that is positioned at a fixed location. Other embodiments comprise wireless devices other than RFID-based devices. For example, the mobile device 20 may comprise an ultra wide band (UWB) transceiver which wirelessly communicates with another UWB transceiver positioned at a fixed location.

As explained above, the tag 30 is positioned at a fixed and known location. The location of the tag can be denoted in accordance with a variety of techniques such as longitude and latitude coordinates, relative location to another known location, etc. Location information indicative of the location of the tag 30 is stored in the tag's storage 34. The storage may comprise any suitable type of storage medium such as random access memory (RAM), flash memory, electrically erasable read-only memory (EEPROM), etc, and/or combinations thereof. The location information indicative of the tag's location is loaded into storage 34 in accordance with any of a variety of techniques. For example, the location information can be wirelessly transmitted to the tag's transceiver 32 from a programming device (not specifically shown).

In accordance with embodiments in which the mobile device 20 and tag 30 are RFID-compliant, the reader 24 emits a periodic wireless signal (e.g., a beacon) that, when in range of transceiver 32 causes the tag 30 to echo back a wireless response signal along with an identifier associated with the tag. In at least some embodiments, the identifier differentiates the tag 30 from other tags. Upon receipt of the response signal, the mobile device 20 is able to determine that the mobile device is within range of the tag 30. The tag 30 also retrieves its location information from storage 34 and transmits the location information to the mobile device's reader 24. The location information can be transmitted within the response signal or as part of a separate wireless transmission. Moreover, the signal emitted by the reader 24 causes, and in some embodiments automatically causes, the tag's transceiver 32 to transmit the tag's location information to the reader's transceiver 26. The wireless signal may be automatically emitted at predetermined fixed or programmable periodic intervals. Additionally or alternatively, the mobile device 20 can be manually activated by its user to emit a wireless signal.

In some embodiments, the tag 30 is passive (i.e., the tag does not have its own source of power) and in other embodiments, the tag is active or semi-passive (i.e., has its own source of power). In accordance with at least some embodiments, the range at which the mobile device 20 and tag 30 can engage in effective communications depends on whether the tag is passive or active as well as one or more other factors such as the communication frequency, the transmit power, etc. In embodiments in which the tag is passive, communications are limited to less than about 3 meters and in some embodiments 2 feet or less, while if the tag is active, communications are limited to less than about 200 feet. In either case, once the mobile device 20 has been informed of the location of the tag 30, the location of the mobile device 20 is then known, estimated, or inferred, at least within the effective communication range of the tag. For example, if the effective communication range is 3 meters or less, then the mobile device knows its location to be within 3 meters of the location of the tag.

In some embodiments, Near Field Communication transceivers and tags can be used. NFC transceivers and tags operate at relatively short range and can act as either transceivers (active mode) or passive tags with an on-demand response (passive mode where one device generates the RF field while the other device uses load modulation to transfer the data). NFC-enabled devices are interoperable with contactless smart-cards and smart-card readers conforming to these protocols. The effective communication range for NFC-based devices is generally less than about 1 foot and in some embodiments less than about 8 inches Communication is terminated either by a command from the application or when devices move out of range. In accordance with such embodiments, a user of an NFC-enabled mobile device could move his mobile device (e.g., cellular telephone) in proximity of an NFC transceiver or tag, for example, to purposely sync the user's position or this might happen automatically upon purchasing an item at a store.

FIG. 3 illustrates a method 70 usable in accordance with embodiments of the invention. At 72, the mobile device emits a wireless signal. The wireless signal is detected by the tag at 74. In some embodiments, such as those described above, the wireless signal cannot be detected by the tag until the mobile device is within range (e.g., within 3 meters, 200 feet, or 1 foot as noted above) of the tag. The tag retrieves its location information at 76 and transmits its location information to the mobile device 20 at 78. The location information of the tag 30 is thus received by the mobile device and is provided to the host logic 24.

Once the mobile device 20 has determined its location, or an approximation of its location, the location can be provided by host logic 24 to assist the location-determining subsystem 25 (action 80). How the location-determining subsystem 25 uses the location depends on the type of technology on which the location-determining subsystem is based. For example, if the location-determining subsystem 25 comprises a GPS receiver, the location determined via the reader and tag combination is used to assist calculations during a satellite search process such as a cold start or to utilize additional signal processing to enable GPS reception in relatively weak signal environments, such as inside a building or other structure. Once the location-determining subsystem 25 (GPS receiver) is informed of its location, the location-determining subsystem can acquire the requisite number of satellites to fix its own location faster than if the location-determining subsystem was unaware of its location. The assistance data from the nearby tag sets a starting point for the GPS algorithms. Knowing approximate location on the earth enables the mobile device to calculate which satellites are in view, and this information allows the algorithms to exclude a large portion of the calculations and search parameters. With this approximate information, the algorithm can search for the expected satellites at the exact times when they are ‘visible’ overhead. This search preferably is enhanced down to the period of time in which the satellite signal will be transmitted. If there are also stored satellite ephemerides that are current (less than 2-4 hours old), the doppler shifts for the satellites in view can also be computed. These then become the centers of the frequency searches that are used by the location determining subsystem 25 to locate each satellite.

In embodiments in which the location-determining subsystem 25 comprises an inertial navigation system, the location determined via the reader and tag combination is used to synchronize or re-synchronize the location-determining subsystem. As noted above, errors in an inertial system's ability to track position relative to a known point aggregate over time. Once the mobile device is able to determine its location using the reader/tag interaction, the inertial navigation-based location-determining subsystem can switch from, or replace, its previously used known location to the newly determined known location, or estimate a replacement location for the previously used known location based on the location newly determined via the reader/tag combination, and begin measuring position and/or velocity relative to the newly determined location. In some embodiments, the mobile device could update its location based on the location information obtained via the reader/tag interaction and based on the location currently used by the inertial navigation-based location-determining subsystem. For example, if the inertial navigation-based location-determining subsystem has an accuracy of +/−20 feet (based at least in part on drift as explained previously) and the reader passes near a tag that has a range of 10 feet, then the inertial guidance subsystem or host logic 22 could cross-correlate the two pieces of information to determine an improved estimate of the location of the mobile device.

While the preferred embodiments of the present invention have been shown and described, modifications thereof can be made by one skilled in the art without departing from the spirit and teachings of the invention. For example, the communication between the communication device and tag/reader can be infra-red (IR)-based or dominated by magnetic field interaction, instead of wireless radio frequency (RF)-based as in the case of RFID, The scope of protection is not limited by the description set out above. Each and every claim is incorporated into the specification as an embodiment of the present invention.

What is claimed is:

1. A mobile device, comprising:
a location-determining subsystem; and
a location assistance subsystem operatively coupled to said location-determining subsystem, said location assistance subsystem wirelessly communicates with a transceiver that is external to said mobile device to receive location information of said transceiver;
wherein said location information is used by the location-determining subsystem.

2. The mobile device of claim 1 wherein said location assistance subsystem comprises a radio frequency identification (RFID) reader or tag.

3. The mobile device of claim 1 wherein said location assistance subsystem comprises a near field communication transponder.

4. The mobile device of claim 1 wherein said location-determining subsystem comprises a global positioning system (GPS) receiver.

5. The mobile device of claim 4 wherein said location information is used to search for a satellite.

6. The mobile device of claim 1 wherein said location-determining subsystem determines its location relative to a predetermined point.

7. The mobile device of claim 6 wherein said location information is used to synchronize or update said location-determining subsystem.

8. The mobile device of claim 6 wherein said location information is used as a new predetermined point or is used to estimate e new predetermined point.

9. The mobile device of claim 1 wherein said location-determining subsystem comprises a global positioning system (GPS) receiver and said location assistance subsystem comprises a radio frequency identification (RFID) reader or tag.

10. The mobile device of claim 1 wherein said location-determining subsystem comprises a global positioning system (GPS) receiver and said location assistance subsystem comprises a near field communication transponder.

11. A mobile device, comprising:
a location-determining subsystem; and
a first transceiver coupled to said location-determining subsystem and adapted to wirelessly communicate with a second transceiver that is external to said mobile device, said second transceiver positioned at a fixed location and comprising location information indicative of said fixed location;
wherein said first transceiver causes the second transceiver to transmit said location information to the first transceiver and said location information is used by the location-determining subsystem.

12. The mobile device of claim 11 wherein said location-determining subsystem comprises a global positioning system (GPS) receiver.

13. The mobile device of claim 12 wherein said location information is used to search for a satellite.

14. The mobile device of claim 11 wherein said location-determining subsystem determines its location relative to a predetermined point.

15. The mobile device of claim 14 wherein said location information is used to synchronize or update said location-determining subsystem.

16. The mobile device of claim 12 wherein said location information is used as a new predetermined point or is used to estimate a new predetermined point.

17. A method, comprising.
a mobile device receiving a location of a component external to said mobile device; and
using the external component's location to assist a location-determining subsystem of the mobile device;
wherein said location-determining subsystem comprises a subsystem selected from a group consisting of a global positioning system (GPS) and an inertial navigation system.

18. The method of claim 17 wherein determining the location of the external component comprises using radio frequency identification (RFID).

19. The method of claim 17 wherein determining the location of the external component comprises using a near field communication transponder.

20. The method of claim 17 wherein using the external component's location for the location-determining subsystem comprises using the location to search for a satellite.

21. The method of claim 17 wherein the location determining subsystem comprises an inertial navigation system and wherein using the external component's location to assist the location-determining subsystem comprises using the location to synchronize the inertial navigation system.
